(19) United States
(12) Patent Application Publication
(10) Pub. No.: US 2019/0330918 A1
(43) Pub. Date: Oct. 31, 2019

(54) MAGNETIC BLIND CORD SAFETY MANAGEMENT DEVICE

(71) Applicant: PARFITT CREATIVE, LLC, PACIFICA, CA (US)

(72) Inventors: BENJAMIN JOHN PARFITT, pACIFICA, CA (US); LESLIE MAE GREEN, PACIFICA, CA (US)

(21) Appl. No.: 16/373,623

(22) Filed: Apr. 2, 2019

Related U.S. Application Data
(60) Provisional application No. 62/669,839, filed on May 10, 2018.
(60) Provisional application No. 62/651,521, filed on Apr. 2, 2018.

(51) Int. Cl. E06B 9/326

(52) U.S. Cl. CPC E06B 9/326

(57) ABSTRACT

The magnetic blind cord management system comprises at least three independent pieces designed to both retain blind cord(s) and magnetically elevate and store cord(s) out of harms reach of children and pets; the first and second pieces attach to the blind cord(s) by mechanically fitting together to contain the cord(s) in between the center of the two connected pieces, thus forming a cord retention mechanism (or cord retainer), the third independent piece is mounted on a wall or surface adjacent to the blinds; the cord retainer and the third piece both form a magnetically attracted first and second half suitable for establishing a retention of the cord(s) in a mounted position, enabling cord(s) to be elevated out of reach of children and pets to prevent strangulation; and also suitable for establishing a simplified and reliable way for the operator to utilize blind cord(s) with less hassle (compared to other safety mechanisms which require winding and unwinding of cord(s)), making it as simple as possible for operators to implement and maintain blind cord safety in their homes. Additionally, the cord retainer, which comprises the first and second pieces fit together, remains attached to blind cords once installed, though the two independent pieces have the ability to separate when downward force, greater than the force which holds the first and second pieces together, is applied to the cord retainer, preventing the formation of a closed-loop system and reducing the risk of strangulation should a child or pet get tangled in the cords. Tassels remain intact.

### CROSS-REFERENCE TO RELATED APPLICATIONS

This application claims the benefit of priority of U.S. Provisional Application No. 62/651,521 entitled MAGNETIC BLIND CORD SAFETY DEVICE, filed Apr. 2, 2018 and U.S. Provisional Application No. 62/669,839 entitled MAGNETIC BLIND CORD SAFETY MANAGEMENT DEVICE, filed May 10, 2018. The contents of all applications are hereby incorporated by reference herein in their entirety.

### BACKGROUND OF THE INVENTION

This invention relates to a blind cord safety management system designed to address the current needs of families, who have corded blinds in their home and who need a simple, reliable solution for getting cords out of reach of children and pets. At present, it is typical for Venetian blinds, Roman shades, and other similar items to have one, two, or more cords for manual operation. The free ends of these cords hang from one of the sides of the blind, and typically have ends that pass through a tassel. These dangling blind cords still cause injury and death to children and pets every year due to strangulation, despite improvements in safety features of blinds currently sold on the market. Regardless of whether tassels are connected or separable, the simple fact that the blinds have any hanging cord(s) poses a risk of strangulation as the cord(s) can become looped or knotted at any time.

Also, many families still have older blinds in their homes, which lack safety features. It is important to note that even with added safety features, a single dangling cord can pose a strangulation hazard. To address these needs, the proposed magnetic blind cord management system establishes a simplified, reliable way for users to physically lift and store cords out of the reach of children, considering the user-experience during both installation and continuing use of blinds.

Notably, there are various cord retainers currently on the market consisting of two complementary pieces, though they typically involve a mechanism for winding and securing the cords in some manner to both shorten and elevate the cords out of reach of children. The problem of these winding mechanisms is that they can pose a hassle to the user both during installation, if the user has to wind cords, and during continued use of blinds if they are required to continually wind and unwind blind cords. Also, some cord shortening mechanisms can be unreliable in retaining the cords, and can separate easily during normal use of blinds. Therefore, the proposed magnetic blind cord management system addresses these problems by providing a magnetic component enabling the cord retainer, and consequently, the blind cord(s) to be mounted high out of reach of children and pets.

### SUMMARY OF THE DISCLOSURE

One embodiment of a cord management device comprises the following elements. A body defines a passageway which is sized to allow at least one cord to pass through the body. A first magnet is attached to the body. A second magnet is configured to be attached to an external surface, such as a wall or door frame, for example. The first and second magnets are arranged such that a back side surface of the body is releasably attachable to a front side of the second magnet.

One embodiment of a cord retention device comprises the following elements. A body defines a passageway that is sized to allow at least one cord to pass through the body. The body comprises a first piece defining top and bottom slots and an open face; a second piece configured to releasably attach to the first piece and sized to cover said open face of the first piece, such that when the second piece is attached to the first piece the body defines an interior compartment. A first magnet is attached to the body. A second magnet is configured to be attached to an external surface. The first and second magnets are arranged such that a back side surface of the body is releasably attachable to a front side of the second magnet.

### DESCRIPTION OF DRAWINGS

FIG. 1 is a perspective view of a cord management device according to the disclosure.

FIG. 2a is to plan view of a body of a cord management device according to the disclosure.

FIG. 2b front elevation view of the body of FIG. 2a.

FIG. 2c is a right side elevation view of the body of FIG. 2a.

FIG. 3a is to plan view of a second magnet of a cord management system according to the disclosure.

FIG. 3b front elevation view of the second magnet of FIG. 3a.

FIG. 3c is a right side elevation view of the body of FIG. 3a.

FIG. 4a is front side view of the cord management system according to the present disclosure with the cord management device shown in the detached configuration.

FIG. 4b is a front side view of the cord management system according to the present disclosure with the cord management device shown in the attached configuration.

FIG. 5a is a front perspective view of a cord retention device according to the present disclosure.

FIG. 5b is a back perspective view of a cord retention device according to the present disclosure.

FIG. 5c is a back perspective view of a cord retention device according to the present disclosure with the second piece removed to expose the interior of the body.

FIG. 6 is an exploded view of a cord retention device according to the present disclosure.

### DETAILED DESCRIPTION OF THE DISCLOSURE

The present disclosure is provided herein with reference to certain embodiments, but it is understood that the disclosure can be embodied in many different forms and should not be construed as limited to the embodiments set forth herein. In particular, the present invention is described below in regards to certain cord management systems and devices for use with household blinds, but it is understood that elements of the embodiments described can be used in other systems and also to retrofit and/or upgrade different types of blinds. The systems can also be used with many different types of blinds that have cords, beyond those described herein, and indeed with any systems having hanging cords where it is desirable to increase the height of the cords above the floor.

It is understood that when an element is referred to as being “on” another element, it can be directly on the other element or intervening elements may also be present. Furthermore, relative terms such as “inner,” “outer,” “upper,” “above,” “lower,” “beneath,” and “below,” “top,” “bottom,” and similar terms, may be used herein to describe a relationship of one element to another. It is understood that these terms are intended to encompass different orientations of the device in addition to the orientation depicted in the figures.

Although the ordinal terms first, second, etc., may be used herein to describe various elements, components, regions and/or sections, these elements, components, regions, and/or sections should not be limited by these terms. These terms are only used to distinguish one element, component, region, or section from another. Thus, unless expressly stated otherwise, a first element, component, region, or section discussed below could be termed a second element, component, region, or section without departing from the teachings of the present invention.

Embodiments of the invention are described herein with reference to certain views that are schematic illustrations. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region of a device and are not intended to limit the scope of the invention unless specifically so stated in a claim.

Certain embodiments of the invention relate to a blind cord management system comprising two magnetically attracted pieces used to retain blind cord(s) in mounted position, elevated out of the reach of children and to provide a simplified means of removing blind cord(s) from mounted position for utilization. The management system comprises at least one first piece and a second piece, both independent. The first piece is attached to blind cord(s) via a cord retention mechanism in which the cord(s) slide through an opening slit on one side of the piece and are contained in a larger hole in the center of the piece, the second piece is mounted on a wall or surface adjacent to blinds. Both pieces form a magnetically attracted first half and second half suitable for establishing a retention of the cord(s) in a mounted position, enabling cords(s) to be elevated out of reach of children to prevent strangulation; and also suitable for establishing a simplified way of removing cord(s) from mounted position in order to utilize cords, providing less hassle to the operator. While other blind cord management systems typically involve winding and securing the cords in some manner to both shorten and elevate the cords out of reach of children, the proposed magnetic blind cord management system allows for the cords to be contained simply by a single piece (the first piece) and mounted vertically to an adjacent wall or surface by the magnetic attraction between the first and second pieces.

Other embodiments of the disclosed system comprise three independent pieces. The first and second pieces attach together, enclosing the cords in between the two pieces, thus forming a cord retainer, which will remain attached to the cords after it is installed and remain throughout normal use of blinds. Installation of the cord retainer first requires the user to place the blind cord(s) within a designated groove running through the diameter of the first piece. Secondly, in order to retain the cord(s), the user is required to align a second piece to the first piece, placing it over the embedded cord(s), and then press the first and second pieces together until they are connected, enclosing the cord(s) through the center of the two joined parts. The first and second pieces are designed to have compatible and complementary shapes allowing them to join together and remain attached under normal tension and use of blind cord(s). However, the joined first and second pieces are designed to separate when downward force, greater than the force that holds them together, is applied to the cord retainer. This would help prevent the formation of a closed-loop system and reduce the risk of strangulation should a child or pet get tangled in the cords.

The first and second pieces of the cord retainer fit together due to the first piece forming a shell with a lip around the outer edge, while the second piece is able to fit within the first piece by applying pressure pushing the two pieces together, which allows the second piece to be wedged under the outer lip of the first piece. There are, however, many variations that can form complementary shapes, which would allow two independent pieces to attach together.

The third independent piece is mounted on a wall or surface adjacent to the blinds. Both the cord retainer and the third piece form a magnetically attracted first and second half suitable for establishing a retention of the cord(s) in a mounted position, enabling cord(s) to be elevated out of reach of children and pets to prevent strangulation; and also suitable for establishing a simplified and reliable way for the operator to utilize blind cord(s) with less hassle to the operator (compared to other safety mechanisms which require winding and unwinding of cord(s)), making it as simple as possible for operators to implement and maintain blind cord safety in their homes.

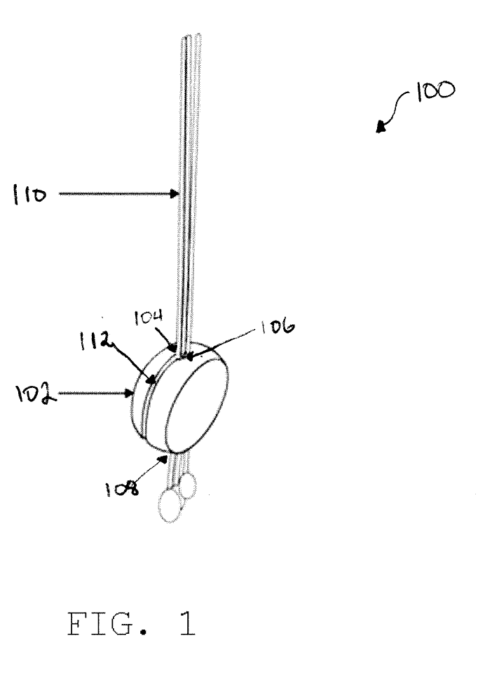

FIG. 1 shows one embodiment of a cord management device (100) according to the present invention comprising a first piece body (102) with a passageway (104) that runs through the body (102) between a top opening (106) and a bottom opening (108) and is sized to allow at least one cord (110) to pass through the body (102). The body (102) can be composed of a silicone, rubber, or similar material, providing the flexibility properties necessary to bend a longitudinal slit (112) along one side of the body (102) and connecting with the passageway (104). As shown in FIG. 1, the slit (112) is narrower than the passageway (104) and sized such that the at least one cord (110) can slide through the slit (112) and into the passageway (104).

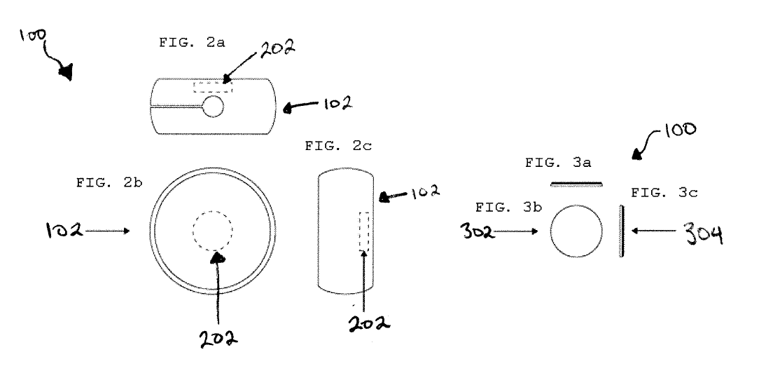

FIGS. 2a through 2c show the cord management device (100) further comprising a first magnet (202) attached to or embedded within the body (102).

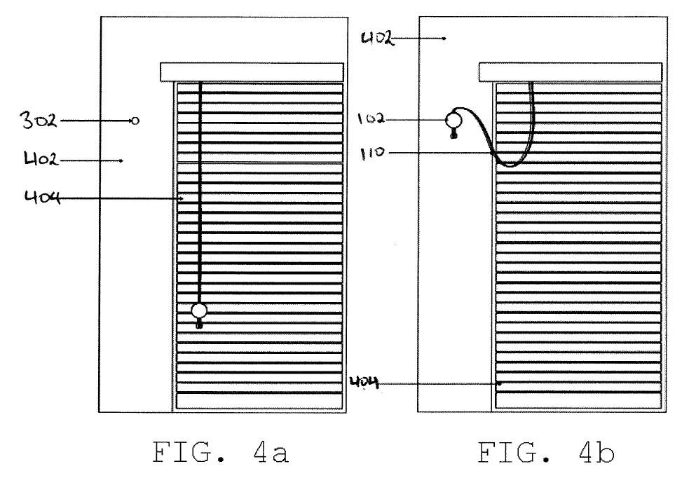

FIGS. 3a through 3c show the cord management device (100) further comprising a second piece (302) comprising a magnetically attractive material, such as a magnet, steel plate, or other magnetically attractive metal. On a back side surface of the second piece (302), an attachment mechanism (304) (e.g., an adhesive) can be applied to attach the second piece (302) to an external surface.

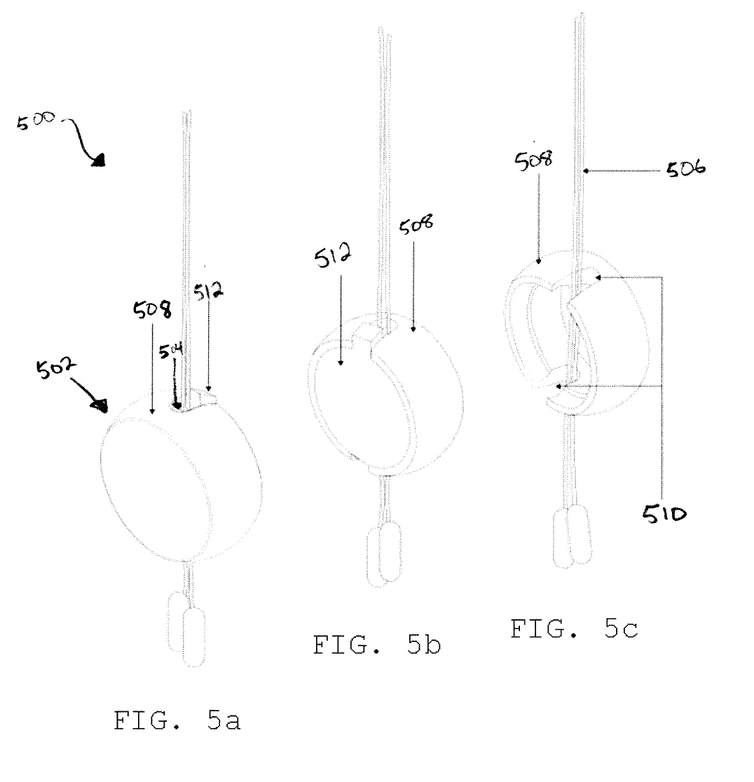

FIG. 4a shows the second piece (302) mounted on an external surface (402) adjacent to a set of blinds (404). FIG. 4b shows a back side surface of the body (102) attached to a front side of the second piece (302) from the magnetic attraction between the first magnet (202) and the second piece (302). The force of this magnetic attraction can be less than the force of adhesion of the second piece (302) to the external surface (402). Thus, upon application of force or tension to dismount the at least one cord (110) retained by the body (102), the first magnet (202) and the second piece (302) will release leaving the second piece (302) mounted on the external surface (402) and the body (102) attached to and retaining blind cords, as shown in FIG. 4a.

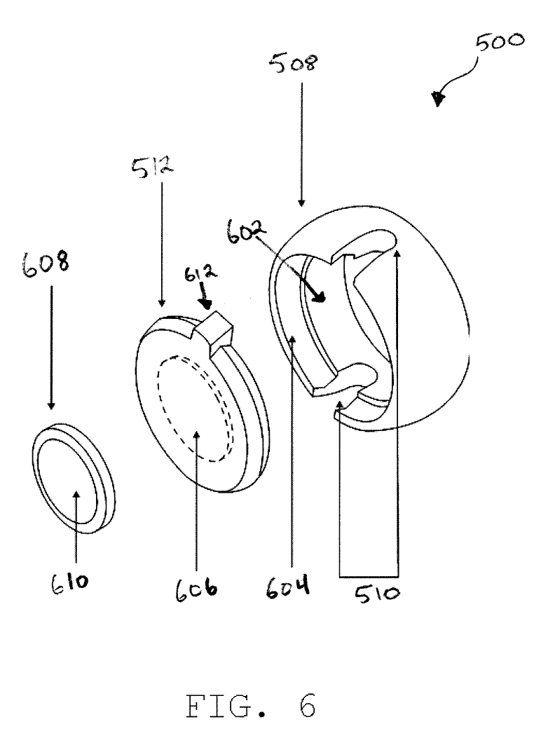

FIGS. 5a through 5c show one embodiment of a cord retention device (500) according to the present invention comprising a body (502) with a defined passageway (504) sized to allow at least one cord (506) to pass through the body (502). The body (502) comprises a first piece (508), which can be composed of a hard plastic or similar material, providing the firm properties necessary to create a supporting frame, which is the first half of the body (502). The passageway (504) runs through a top and bottom slot (510) on the first piece (508), which allows for the at least one cord (506) to pass through the diameter of the first piece (508). The at least one cord is secured within the cord retainer when the second piece (512), or second half of the body (502), is placed over the at least one cord (506) and attached to the first piece (508).

The second piece (512) forms the second half of the body (502). The body (502) is formed when the second piece is placed over the embedded at least one cord (506) and then becomes attached to the first piece (508) by means of pressing the two pieces together such that the second piece (512) becomes embedded in the first piece (508) (i.e., press-fit).

As shown in FIG. 6, the first piece (508), which forms the first half of the body (502), comprises an open face (602) and a lip (604) feature to retain the second piece (512). The top and bottom slots (510) of the first piece (508) allow the at least one cord (506) to pass through the body (502). The second piece (512) will be composed of a silicone, rubber, or similar material, providing the flexible properties needed to bend and fit under the lip (604) of the first piece (508) and sized to cover the open face (602) of the first piece (508), so that the second piece (512) is releasably attached to the first piece (508). The second piece (512) forms the second half of the body (502) and, when attached to the first piece (508), defines an interior compartment of the body (502). Embedded within the first piece (508) is a magnet, steel plate, or other magnetically attractive metal (606). The third piece (608) will comprise a magnetically attractive material, such as a magnet, steel plate, or other magnetically attractive metal. The second piece (512) may consist solely of the magnetic material, or it may be embedded in. On a back side surface of the second piece (512), an attachment mechanism (610) can be applied for attachment to an external surface. Both the body (502) and third piece (608) will form magnetically attracted halves and contain magnetic elements such that a back side surface of the body (502) is releasably attachable to a front side of the magnetic material of the third piece (608). The second piece (512) may further comprise a tab (612) that aligns with the top opening (510) of the first piece (508) when the second piece (512) is attached to the first piece (508) and protrudes from the body (502) when the second piece (512) is attached to the first piece (508) to facilitate detachment of the second piece (512) from the first piece (508).

Embodiments of the current invention provide a solution for a cord retainer, which allows the blind cord(s) to be retained, and which has a magnetic feature allowing the cord retainer to be magnetically mounted adjacent to the blinds, and which breaks apart or is released from the cords when downward pressure or tension is exerted on the cords. The proposed design of the cord retainer is not the only design that would allow for these same essential performance features.

In certain embodiments, the cord retainer is composed of a single piece, with an embedded magnet, and with an opening slit, which helps to retain the cords, and which allows the cords to be released through the slit with downward/outward pressure from the cords.

In certain embodiments, the cord retainer is composed of two separate pieces, part A and part B, which each have a magnetic component, and stick together with magnetic attraction to retain the cords. The magnetic components allow the cord retainer to be mounted magnetically, and also allows Part A and Part B to separate when the applied force is greater than the force holding the magnetic pieces together.

In certain embodiments, the cord retainer is composed of two separate pieces, which have a press fit function, in which Part A and Part B snap together due to a ridge/lip/edge on Part A which fits over a compatible ridge/lip/edge on Part B, thus holding Part A and Part B joined together, with the ability to separate into two separate pieces when outward tension or force is applied. Part B has a magnetic feature enabling the cord retainer to be mounted.

In certain embodiments, the cord retainer is composed of two separate pieces, which have a press fit function, in which Part A and Part B snap together due to a ridge/lip/edge on Part B which fits over a compatible ridge/lip/edge on Part A, thus holding Part A and Part B joined together, with the ability to separate into two separate pieces when outward tension or force is applied. Part B has a magnetic feature enabling the cord retainer to be mounted.

In certain embodiments, the cord retainer is composed or two separate pieces, Part A and Part B, which fit together with a hinge mechanism and a clasp, which allow the two pieces to enclose the blind cord(s), but will open to release cords when outward pressure is applied greater than the tension holding the pieces together.

In certain embodiments, the cord retainer is composed of at least two pieces, with each piece containing an individual cord. With multiple cords, there are equal multiple pieces that fit together either magnetically or with a press fit mechanism to form the cord retainer. The cord retainer has a magnetic component, which allows the combined cords to be mounted. The cord retainer can break apart when force is applied greater than that which holds the individual pieces together.

Although the present disclosure has described in detail certain configurations of the devices and systems, other versions are possible. Embodiments of devices and systems according to the present disclosure can comprise any combination of compatible features shown in the various figures, and these embodiments should not be limited to those expressly illustrated and discussed. Therefore, the spirit and scope of the invention should not be limited to the versions described above.

We claim:

1. A cord management device, comprising:
a body defining a passageway sized to allow at least one cord to pass through said body;
a first magnet attached to said body;
wherein said first magnet is arranged such that a back side surface of said body is releasably attachable to an external surface.

2. The cord management device of claim 1, wherein said passageway runs through said body between a top opening and a bottom opening.

3. The cord management device of claim 1, said body further defining a longitudinal slit along one side of said body, said slit connecting with said passageway.

4. The cord management device of claim 3, wherein said slit is narrower than said passageway, said slit sized such that at least one cord can slide through said slit and into said passageway.

5. The cord management device of claim 1, said body further comprising:
a first piece defining top and bottom slots and an open face;
a second piece configured to releasably attach to said first piece and sized to cover said open face of said first piece, such that when said second piece is attached to said first piece said body defines an interior compartment.

6. The cord management device of claim 5, said second piece comprising a tab that aligns with said top opening of said first piece when said second piece is attached to said first piece, said tab protruding from said body when said second piece is attached to said first piece to facilitate detachment of said second piece from said first piece.

7. The cord management device of claim 1, wherein said first magnet is within said body.

8. The cord management device of claim 1, wherein said body is magnetically attachable to a second magnet.

9. The cord management device of claim 8, said second magnet comprising an attachment mechanism on a back side of said second magnet for attachment to an external surface.

10. The cord management device of claim 8, said second magnet comprising an adhesive for attachment to an external surface.

11. A cord retention device, comprising:
a body defining a passageway sized to allow at least one cord to pass through said body, said body comprising:
a first piece defining top and bottom slots and an open face;
a second piece configured to releasably attach to said first piece and sized to cover said open face of said first piece, such that when said second piece is attached to said first piece said body defines an interior compartment;
a first magnet attached to said body;
a second magnet configured to be attached to an external surface;
wherein said first and second magnets are arranged such that a back side surface of said body is releasably attachable to a front side of said second magnet.

12. The cord retention device of claim 11, wherein said passageway runs through said body between a top opening and a bottom opening.

13. The cord retention device of claim 11, said second piece comprising a tab that aligns with said top opening of said first piece when said second piece is attached to said first piece, said tab protruding from said body when said second piece is attached to said first piece to facilitate detachment of said second piece from said first piece.

14. The cord retention device of claim 11, wherein said first magnet is within said body.

15. The cord retention device of claim 11, said second magnet comprising an attachment mechanism on a back side of said second magnet for attachment to an external surface.

16. The cord retention device of claim 11, said second magnet comprising an adhesive for attachment to an external surface.

17. The cord retention device of claim 11, wherein said second piece attaches to said first piece with a press-fit.

18. A blind system, comprising:
a plurality of blinds;
a frame for attaching said blinds to an external surface;
at least one cord for retracting and releasing said blinds;
a cord retention device, comprising:
a body defining a passageway, said at least one cord passing through said passageway;
a first magnet attached to said body;
a second magnet configured to be attached to an external surface;
wherein said first and second magnets are arranged such that a back side surface of said body is releasably attachable to a front side of said second magnet.

19. The blind system of claim 18, wherein, when said blind system is mounted to an external surface, said cord retention device holds said at least one cord such that a bottom portion of said at least one cord hangs at a height that is higher above the ground than if said at least one cord were not passing through said cord retention device.
